(19) United States
(12) Patent Application Publication
(10) Pub. No.: US 2023/0050121 A1
(43) Pub. Date: Feb. 16, 2023

(54) IN-SITU FINES CAPTURE FROM FLUID FINE TAILINGS

(71) Applicant: SYNCRUDE CANADA LTD. IN TRUST FOR THE OWNERS OF THE SYNCRUDE PROJECT AS SUCH O, Calgary (CA)

(72) Inventors: Nan WANG, Edmonton (CA); James LORENTZ, Fort McMurray (CA); George DOGBE, Fort McMurray (CA); Wayne MIMURA, Fort McMurray (CA)

(21) Appl. No.: 17/882,372

(22) Filed: Aug. 5, 2022

Related U.S. Application Data
(60) Provisional application No. 63/231,621, filed on Aug. 10, 2021.

(51) Int. Cl. E21B 43/02; B01D 21/00

(52) U.S. Cl. CPC E21B 43/02; B01D 21/0003; B01D 2221/04

(57) ABSTRACT

A process is provided for capturing fines present in fluid fine tailings, in particular, in oil sands fluid fine tailings (FFT), present in a tailings containment structure by spreading coarse sand into the tailings containment structure below an interface that has formed between a water cap and the fluid fine tailings to form a uniform, non-segregating and homogenous fines-rich, a high total solids content mixture that will ultimately form a beach below FFT (BB-FFT) at the bottom of the tailings containment structure.

### TECHNICAL FIELD

The following relates generally to in-situ capture of fines present in fluid fine tailings, in particular, in oil sands fluid fine tailings, present in a tailings facility having a water cap by using sands spreading below the water cap and directly into the fluid fine tailings layer.

### BACKGROUND

Extraction tailings, such as oil sand extraction tailings, are generated from extraction operations that separate valuable material from the mined ore. In the case of oil sand ore, heavy oil or bitumen is extracted from the ore using water, which is added to the oil sand ore to enable the separation of the valuable hydrocarbon fraction from the oil sand minerals.

Oil sand generally comprises water-wet sand grains held together by a matrix of viscous heavy oil or bitumen. Bitumen is a complex and viscous mixture of large or heavy hydrocarbon molecules that contain a significant amount of sulfur, nitrogen and oxygen. The extraction of bitumen from oil sand using hot water processes yields extraction tailings composed of coarse sand, fine silts, clays, residual bitumen and water. Mineral fractions with a particle diameter less than 44 microns are herein referred to as “fines.” These fines are typically clay mineral suspensions, predominantly kaolinite and illite.

Conventionally, oil sand extraction tailings have been stored in various external tailings facilities and mined-out pits, where the coarse solids settle, leaving a fine tailings suspension commonly referred to as “fluid fine tailings” or “FFT”. FFT is generally defined as a liquid suspension of oil sands fines in water with a solids content greater than 2% and having less than an undrained shear strength of 5 kPa. The fact that fluid fine tailings behave as a fluid and have very slow consolidation rates significantly limits options to reclaim oil sand tailings deposits.

It is particularly challenging to dewater or solidify fluid fine tailings (FFT) to the point where these tailings can support standard reclamation equipment and techniques. However, FFT requires long-tern fluid storage, thereby leaving big environmental footprints and posing a risk to regulatory application for new lease development. Because of the slow densification of FFT, it would require hundreds or thousands of years to reach ready-to-reclaim status.

Generally, however, after a few years, the fluid fine tailings do settle to reach a solids content of greater than 30 wt % nominal (i.e., a solids (fines) content of about 30-35 wt % up to about 40 wt %), thereby forming a water layer of recycle water and a more dense FFT layer, which layer is often referred to as a mature fine tailings (MFT) layer.

Current practice is to dredge up the MFT layer from external tailings facilities for ex-situ treatments such as centrifugation, formation of composite tailings with sand and gypsum, treatment with a flocculant such as a high molecular weight nonionic, anionic, or cationic polymer to create a floc structure that will dewater rapidly when deposited in dewatering cells, etc. However, it is becoming increasingly more difficult to dredge the denser MFT for such ex-situ treatments.

Thus, there is a need in the industry for a method for treating fluid fine tailings (FFT) and, in particular, MFT, in-situ, i.e., present in external tailings facilities, to avoid the need for dredging.

### SUMMARY

In one aspect, the present application is directed to an in-situ treatment of fluid fine tailings for densification of FFT comprising spreading coarse sand, for example, coarse tailings sand, into a FFT deposit through a water column and directly into the FFT. Increasing the sand and solids contents of FFT, will increase the strength of the FFT and thereby improve the deposit trajectory towards reclamation. Generally, the coarse sand used in the present process is comprised of about 75 wt % to about 80 wt % particles >44 microns.

In one embodiment, a slurry of coarse tailings sand is introduced below the interface of the water column (generally comprising recycle water) and the FFT, thereby introducing the coarse tailings sand directly into the FFT column to distribute the sands grains uniformly. It is understood, however, that dry coarse sand could also be used, however, it is more difficult to transport large quantities of sand on water. By distributing the sand grains directly into the FFT, fines-rich (e.g., 20-25% by weight <44 microns) beaches below FFT (BB-FFT) having a high total solids content (e.g., 74% to 77% by weight >44 microns on average) can form in about six months. The BB-FFT then forms hard bottoms with the tailings fines being captured therein. It is important that the coarse sands be intentionally introduced into the FFT columns and not simply into the recycle water layer directly above the FFT layer, in order to capture tailings fines in the newly formed BB-FFT.

Thus, in one aspect, a process for capturing fines present in fluid fine tailings that have formed in a tailings facility is provided, comprising:
providing the tailings facility comprising a top layer of water, a middle layer of fluid fine tailings (FFT) and a bottom layer of coarse tailings solids (sand);
spreading coarse sand below an interface between the water layer and the FFT layer directly into the FFT layer; and
allowing a uniform, non-segregating and homogenous fines-rich, a high total solids content mixture to form that will ultimately form a beaches below FFT (BB-FFT) at the bottom of the tailings facility.

In one embodiment, the fluid fine tailings are derived from oil sands extraction operations, including mature fine tailings (MFT), which contain a fines fraction. In another embodiment, the coarse sand is spread as a slurry by adding water to the coarse sand. In another embodiment, the coarse sand is coarse tailings sand derived from oil sands extraction operations.

### BRIEF DESCRIPTION OF THE DRAWINGS

Referring to the drawings wherein like reference numerals indicate similar parts throughout the several views, several aspects of the present process are illustrated by way of example, and not by way of limitation, in detail in the figures, wherein:

FIG. 1 is a schematic of a typical tailings containment structure used for containing tailings streams or tailings products.

FIG. 2 is a schematic of the tailings containment structure of FIG. 1 after sand spreading according to an embodiment of the present process.

FIGS. 3A-D are graphs showing the total solids (wt %) in four (4) columns, each column having a different solids content of FFT (MFT) and different sand-to-fines ratios (SFR), at various heights (cm) above the base of the respective column, six months (December 20) and twelve months (June 21) after sand spreading according to an embodiment of the present process. In particular, FIG. 3A is for the column having 30 wt % FFT+3:1 SFR, FIG. 3B is for the column having 30 wt % FFT+4:1 SFR, FIG. 3C is for the column having 40 wt % FFT+3:1 SFR, and FIG. 3D is for the column having 40 wt % FFT+4:1 SFR.

FIGS. 4A-D are graphs showing the total sand content (wt %, >44 microns) in four (4) columns, each column having a different solids content of FFT (MFT) and different sand-to-fines ratios (SFR), at various heights (cm) above the base of the respective column, six months (December 20) and twelve months (June 21) after sand spreading according to an embodiment of the present process. In particular, FIG. 4A is for the column having 30 wt % FFT+3:1 SFR, FIG. 4B is for the column having 30 wt % FFT+4:1 SFR, FIG. 4C is for the column having 40 wt % FFT+3:1 SFR, and FIG. 4D is for the column having 40 wt % FFT+4:1 SFR.

FIGS. 5A-D illustrate the profiles of pore water pressure measured through cone penetrometer tests (CPT) and calculated total stress and hydrostatic pressure for columns having a different solids content of FFT (MFT) and different sand-to-fines ratios (SFR) twelve months after sand spreading according to an embodiment of the present process. In particular, FIG. 5A is for the column having 30 wt % FFT+3:1 SFR, FIG. 5B is for the column having 30 wt % FFT+4:1 SFR, FIG. 5C is for the column having 40 wt % FFT+3:1 SFR, and FIG. 5D is for the column having 40 wt % FFT+4:1 SFR.

FIGS. 6A and 6B shows the profiles of undrained shear strength (Su) for 30 wt % FFT+4:1 SFR and 40 wt % FFT+4:1 SFR, respectively, twelve months after sand spreading according to an embodiment of the present process.

FIGS. 7A-D show the shear wave velocities inside columns having a different solids content of FFT (MFT) and different sand-to-fines ratios (SFR) twelve months after sand spreading according to an embodiment of the present process. In particular, FIG. 7A is for the column having 30 wt % FFT+3:1 SFR, FIG. 7B is for the column having 30 wt % FFT+4:1 SFR, FIG. 7C is for the column having 40 wt % FFT+3:1 SFR, and FIG. 7D is for the column having 40 wt % FFT+4:1 SFR.

### DETAILED DESCRIPTION

The detailed description set forth below in connection with the appended drawings is intended as a description of various embodiments and is not intended to represent the only embodiments contemplated by the applicant. The detailed description includes specific details for the purpose of providing a comprehensive understanding of the process herein. However, it will be apparent to those skilled in the art that the present process may be practiced without these specific details.

As used herein, “fluid fine tailings” or “FFT” is a liquid suspension of oil sand fines in water with a solids content greater than 2 wt %. “Fines” are mineral solids with a particle size equal to or less than 44μ. “Mature fine tailings” or “MFT” are FFT with a low sand to fines ratio (SFR), i.e., less than about 0.3, and a solids content greater than about 30 wt %.

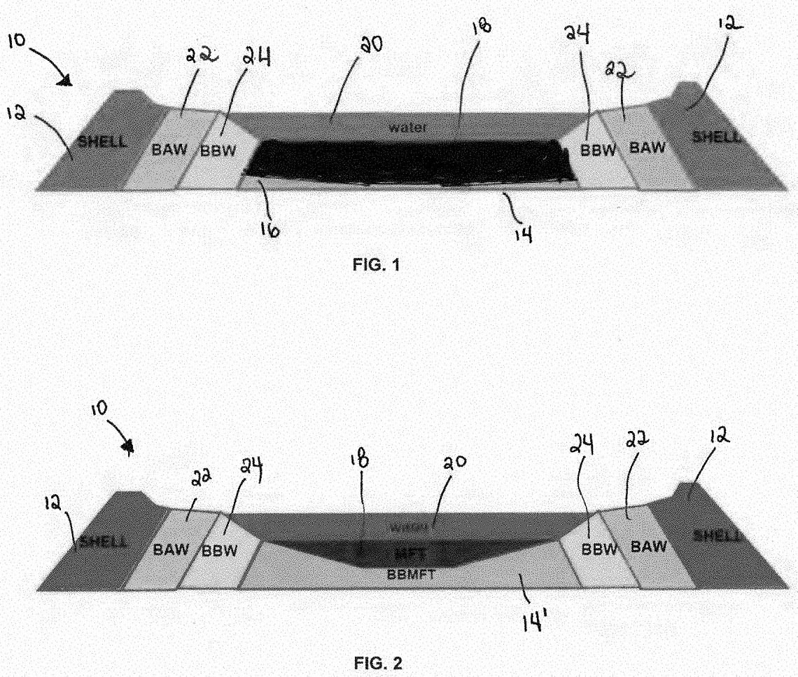

A process for in-place or in-situ densification of fluid fine tailings (FFT) and, in particular, mature fine tailings (MFT) that have formed after several months in external tailings facilities such as mine-out pits, is provided. FIG. 1 illustrates a typical external tailings facility that has been in place for several months. As can be seen in FIG. 1, three distinct layers form when tailings streams are deposited in tailings facility 10. As used herein, the term “tailings streams” means any tailings that are generated from extraction operations that separate valuable material from mined ore, including tailings derived from oil sands extraction operations that contain a fines fraction. Tailings containment 10 comprises two side shells 12 and a bottom 14. Layered on top of bottom 14 is coarse sand 16, which has settled out of the deposited tailings stream. As can be seen in FIG. 1, a large layer of mature fine tailings (MFT) 18 form having a solids (fines) content of about 30-40 wt %, which MFT layer would require hundreds or thousands of years to reach ready-to-reclaim status. A top water layer 14 forms, which is generally comprised of recycle water obtained after bitumen extraction, as for environmental reasons water is reused in the extraction process. Also forming in tailings containment 10 is within shells 12 is beach above water (“BAW”) and beach below water (“BBW”) 24.

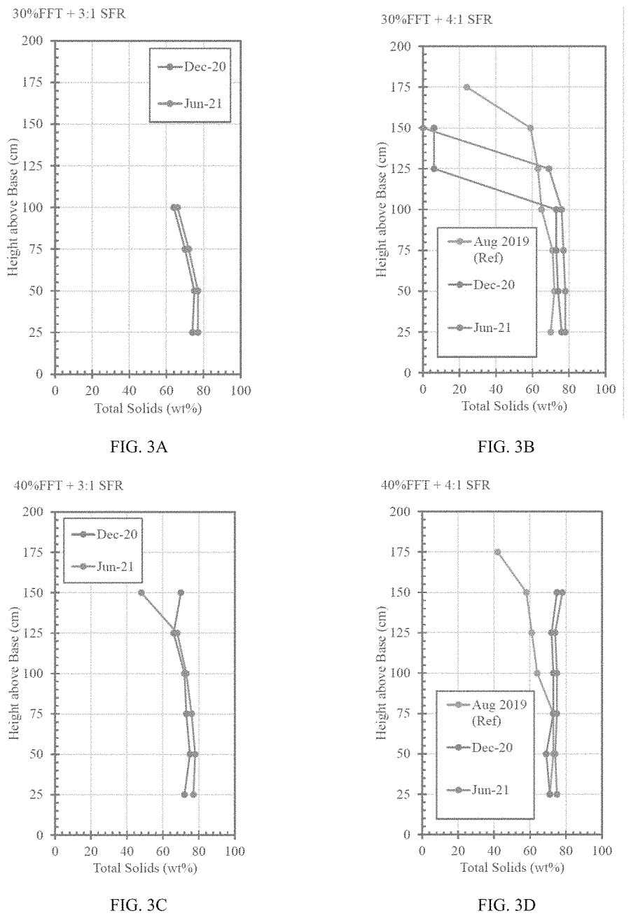

FIG. 2 shows what tailings containment looks like after tailings sand is discharged sub-aerially into the MFT and eventually comes to rest below the MFT layer. The slurry of coarse tailings sand grains is introduced below the interface of recycle water 20 and MFT 18 directly into the MFT 18 column to distribute the sand grains uniformly. The coarse sand can be introduced sub-aerially into the MFT 18 by any number of means, for example, a downpipe such as a radial tremie pipe to ensure uniform spreading of the sand. Once the slurry of sand is introduced into the MFT, much of the fines present in the MFT are captured and are settled out to form a beach below MFT (“BB-MFT”) 14′. As a result, the amount of MFT 18 remaining in the tailings containment 10 is greatly reduced.

The following examples demonstrate that when various tailings streams and products are co-deposited, it improved their individual performance over time, including the material at the interface.

### Example 1

A bench-scale test was done using four (4) columns made from polyvinyl chloride (PVC) that were 40 cm (16 inches) in diameter and approximately 2 meters in height. These columns were instrumented and filled with FFT (also referred to herein as mature fine tailings (MFT) when the FFT has a solids content of about 30 wt % or greater) with varying solids content into which sand was introduced from above to specified target mixture of sand-to-fines ratios (“SFR”). The columns were mounted within wooden frames. The frames were designed to support the column vertically and to provide a means of moving the columns using a forklift. The four columns were placed under the platform. The platform, 10 feet in elevation, was supported using an industrial pallet rack. The platform was used as a work area for feeding sand into the columns. Table 1 shows the different combinations of FFT ratio and proportion of sand added.

TABLE 1

| Column | Solids Ratio | Sand-to-Fines ratio |
|---|---|---|
| Number | of FFT | in mixture |
| 1 | ~30% solids ratio | 3:1 |
| 2 | ~30% solids ratio | 4:1 |
| 3 | ~40% solids ratio | 3:1 |
| 4 | ~40% solids ratio | 4:1 |

A bender element setup was used where three pairs of bender elements were mounted on a 2-inch Unistrut™ channel with the spacing between the pairs at a close distance, generally between 0.5 and 0.75 inches. Testing the bender elements in this configuration suggested that the closer distance between the bender element pairs would increase the likelihood of measuring the shear wave velocity of the material. Shear wave velocity indicates how close solid particles are next to each other. The higher the shear wave velocity, the closer the solid particles to each other.

In addition, for these long-term columns, following sand addition, a water cap was added to the top of the column and a sonar device was placed in each column to monitor the mudline elevation during the column monitoring.

As mentioned above, initially, each of the four columns were filled with FFT and tailings beach sand was introduced into the FFT below the mudline by using a Tremie diffuser device until a sand-to-fines ratio (SRF) was reached, as shown in Table 1. For Columns 1 and 2, the mass of sand fed into the columns was divided into eight containers; for Columns 3 and 4, the sand was divided into 12 containers. The runtime for the loading of each column was 120 minutes. For Columns 1 and 2, each container of sand was loaded into the FFT in 15 minutes, and for Columns 3 and 4, each container was loaded into the column in 10 minutes. After each container of sand had been loaded, the rise in the FFT surface was measured with a Hilti laser distance measuring device. After the initial sand addition, the columns were capped with a water cap and allowed to sit for six (6) months before physical analysis using core sampling was performed to determine total solids (wt %) and wt % sands (>44 microns). The columns were then allowed to sit for an additional six (6) months. After twelve (12) months, core samples were analysed again, as well as performing cone penetrometer testing (CPT), vane shear testing (VST) and shear wave velocities (SWV) analysis.

As mentioned, after both six months and twelve months, core samples of each column were collected at various elevations from each column and examined. A horizontal piston coring method was developed specifically for this application. Seven coring ports were fabricated into the sidewall of the column spaced at 25 cm intervals: 25, 50, 75, 100, 125, 150 and 175 cm referenced from the bottom of the column. A short steel nipple and PVC ball-valve were installed at each of these ports and the valve was set in a closed position. The coring device was a 60-cm long copper pipe with a well-fitted piston that fit snugly in the pipe.

The coring method involved preparing the sample container and coring equipment. The piston was inserted into the core pipe and positioned flush with the lead end of the pipe. The copper pipe was placed into the ball valve, which had a snug fight with the valve. The piston string was tied off to a vertical tripod such that the piston would be held in the same horizontal position while the copper pipe was slid into the FFT column. The valve was then opened and the copper pipe was slid into the column and pushed in until it reached the far wall. The pipe was then slowly slid back out of the column just past the ball valve. The valve was closed and the pipe was fully removed from the column. Finally, the sample was transferred from the copper pipe to a plastic sample bottle. Analysis of the core samples involved determining solids content, sand content, and sand to fines ratio.

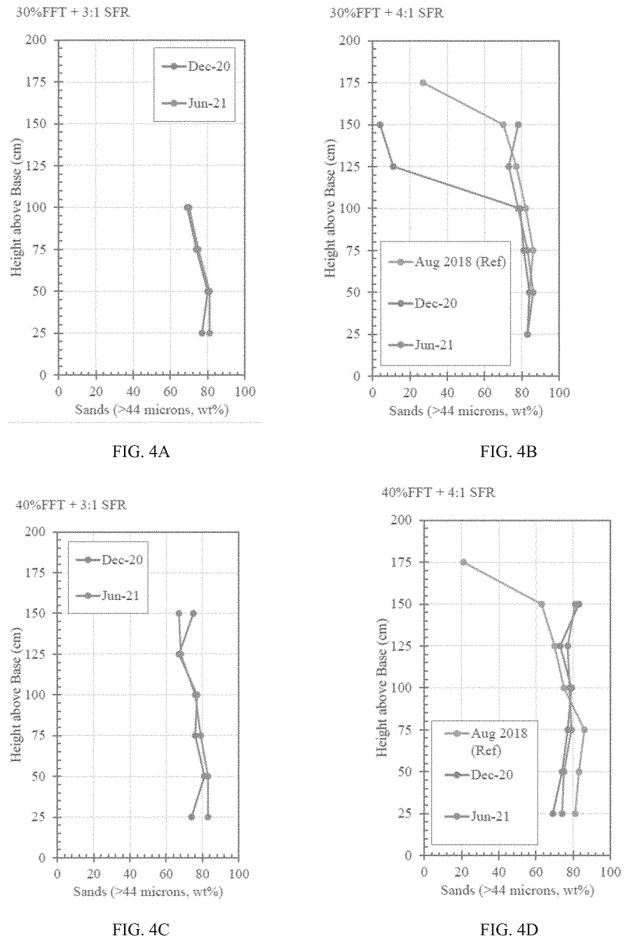

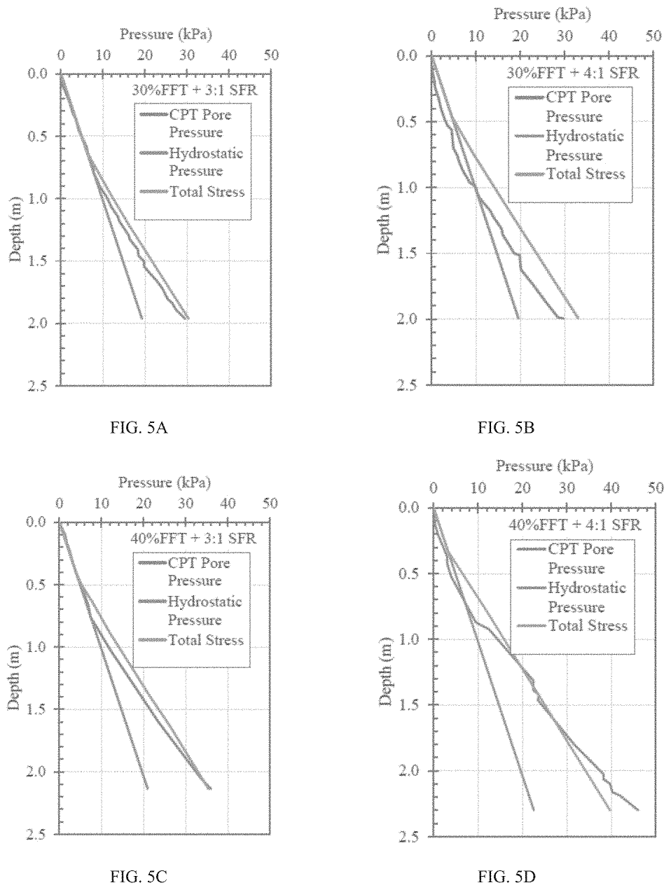

FIGS. 3A-D show the amount of total solids (wt %) at various heights above the base (cm) at six months (December 20) and twelve months (June 21) after spreading sand into the different combinations of FFT ratio and proportion of sand added as shown in Table 1. FIG. 4 shows the amount of sand (wt %, >44 microns) at various heights above the base (cm) at six months (December 20) and twelve months (June 21) after spreading sand into the different combinations of FFT ratio and proportion of sand added as shown in Table 1.

It can be seen in FIGS. 3A-D that the sand spreading operation has resulted in relatively homogeneous mixtures that have consistent solids contents along the depth after six months. The total solids contents have increased from 30 wt % or 40 wt % to about 74 wt % on average. In all cases, the sand/FFT mixtures continued to dewater over the next six months and remained non-segregating over the entire twelve month period. The averaged final solids content after twelve months was about 74.9 wt %, equivalent to a 1.13 void ratio.

It can also be seen in FIGS. 4A-D that the sand spreading operation has created relatively non-segregating mixtures that have consistent sands contents along the depth. The sands contents have increased from nearly 10 wt % to 75-80 wt % over the twelve month period.

In summary, the analyses of core samples revealed that distributing sand grains directly into FFT (MFT) formed relatively homogeneous fines-rich (20-25% by weight, <44 microns) Beaches Below MFT (BB-MFT) with high solids contents (74% by weight on average) in six months. Coarse sand grains were suspending within the mixtures, not settling at the bottom, which enables capture of MFT fines.

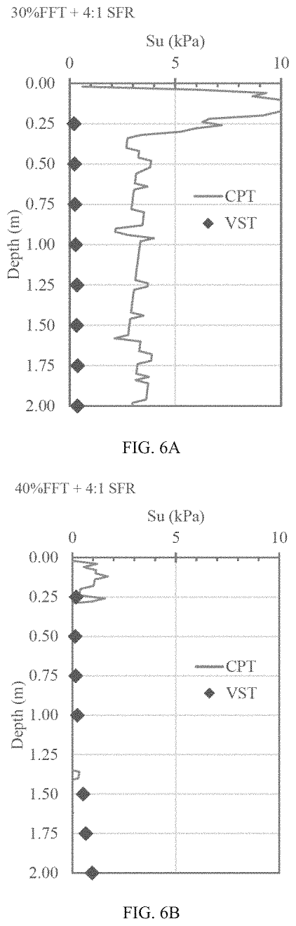

After the twelve month monitoring period, cone penetrometer testing (CPT) was carried out for each column. CPT is a method used to determine the geotechnical engineering properties of soils. The test method consists of pushing an instrumented cone, with the tip facing down, into the columns at a controlled rate. CPT was performed with both a standard cone tip and a ball tip. FIGS. 5A-D illustrate the profiles of pore water pressure measured through CPT and calculated total stress and hydrostatic pressure for each of the sand/FFT mixtures. The difference between the total stress and the pore pressure is defined as the effective stress. When the pore water pressure becomes the same as the hydraulic pressure over time, the solids content of the FFT/sand mixture reaches the maximum.

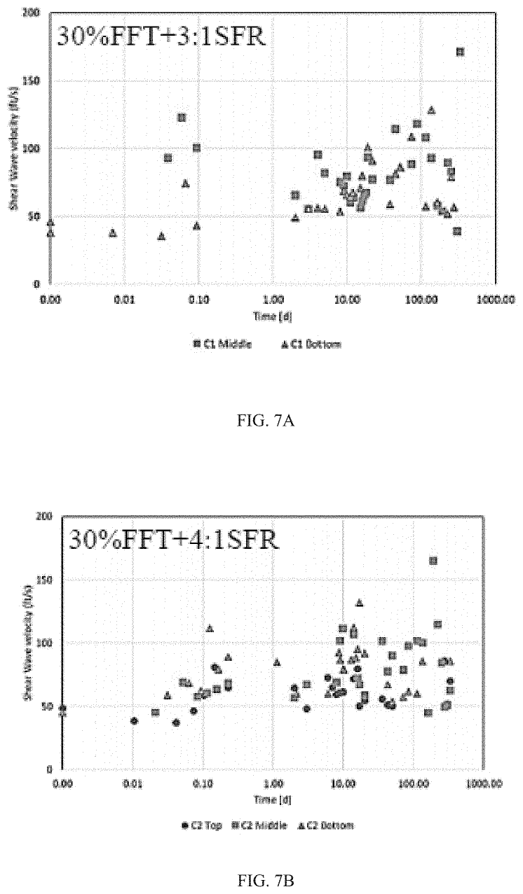

Vane shear tests (VST) were also performed for each column after twelve months. VST is used to measure the undrained shear strength of cohesive soil especially soft clays. VST was performed with a 75-mm diameter by 150-mm tall vane. FIGS. 6A and 6B shows the profiles of undrained shear strength (Su) for 30 wt % FFT+4:1 SFR and 40 wt % FFT+4:1 SFR, respectively. The results show that for the aforementioned FFT and sand mixtures, the mixtures did not seem to possess any undrained shear strengths, likely due to the lack of confining pressure.

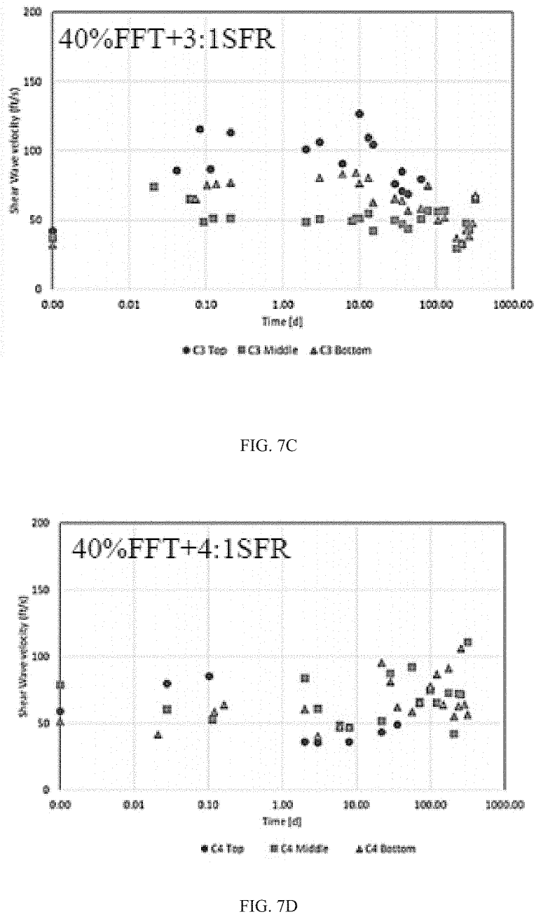

Finally, shear wave velocities were determined by using three pairs of bender elements mounted in the columns at three approximate locations within each column, namely, top (95 cm from the bottom of the column), middle (45 cm from the bottom of the column), and bottom (15 cm from the bottom of the column). FIGS. 7A-D show the shear wave velocities inside each of the sand/FFT mixtures after twelve months. In almost all of the cases, the shear wave velocities inside the sand/FFT mixtures were below 100 ft/s, significantly smaller than ones determined for soils, indicating that the sand/FFT mixtures inside the columns still behaved more as a fluid and did not exhibit a sufficient matrix of soil particles that can effectively transmit elastic waves, even after a duration of one year. The shear wave velocity results show (1) the sand/FFT mixtures were still a fluid one year after deposition; and (2) it will most likely take a longer period of time for the sand grains to touch each other.

In summary, a homogeneous fines-rich sand/FFT mixture of similar solids wt % and sands wt % as the BB-MFT shown in FIG. 2 could be generated by the sand raining below FFT surface technology. The resultant deposits could be characterized as tailings pond hard bottom by the CT09 probe. However, it will take a long time for the sand/FFT mixture to become soil-like materials.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

What is claimed is:

1. A process for capturing fines present in fluid fine tailings that have formed in a tailings facilities, comprising:
(a) providing the tailings facility comprising a top layer of water, a middle layer of fluid fine tailings (FFT) and a bottom layer of coarse tailings solids;
(b) spreading coarse sand below an interface between the water layer and the FFT layer directly into the FFT layer;
(c) allowing a uniform, non-segregating and homogenous fines-rich, a high total solids content mixture to form that will ultimately form a beaches below FFT (BB-FFT) at the bottom of the tailings facility.

2. The process of claim 1, wherein the FFT is derived from an oil sands extraction operation.

3. The process of claim 2, wherein the FFT comprises a low sand to fines ratio (SFR) and a solids content greater than about 30 wt %.

4. The process of claim 3, wherein the SFR is less than about 0.3.

5. The process of claim 1, wherein the coarse sand is coarse tailings sand derived from an oil sands extraction operation.

6. The process of claim 1, wherein the coarse sand is first mixed with water to form a slurry before spreading the coarse sand.

7. The process of claim 1, wherein the FFT has a solids content of about 30 wt % or greater and the coarse sand is spread to give a sand-to-fines (STF) ratio of about 3:1 to about 4:1.
